(19) United States
(12) Patent Application Publication
(10) Pub. No.: US 2024/0239993 A1
(43) Pub. Date: Jul. 18, 2024

(54) FILLER FOR POLYMERIC COMPOSITIONS DERIVED FROM CITRUS PROCESSING AND/OR PRESSING WASTE

(71) Applicant: KRILL DESIGN SRL, Milano (IT)

(72) Inventors: Ivan Calimani, Milano (IT); Yack Humberto Di Maio, Milano (IT); Martina Lamperti, Milano (IT)

(73) Assignee: KRILL DESIGN SRL, Milano (IT)

(21) Appl. No.: 18/561,818

(22) PCT Filed: May 18, 2022
(86) PCT No.: PCT/IB2022/054610

§ 371 Date: Nov. 17, 2023

(30) Foreign Application Priority Data
May 21, 2021 (IT) 102021000013310

(51) Int. Cl. C08K 11/00; B29C 64/118; B29K 67/00; B33Y 10/00; B33Y 70/10

(52) U.S. Cl. CPC C08K 11/005; B29C 64/118; B33Y 10/00; B33Y 70/10; B29K 2067/04; C08K 2201/018

(57) ABSTRACT

The present invention relates to the development of a filler additive derived from processing and/or pressing wastes of the citrus, for polymeric compositions for use in hot processing techniques such as, for example, extrusion, injection molding and 3D printing.

### BACKGROUND ART

In recent years there has been a growing interest in the study and development of innovative materials that can be used as an alternative to the plastic polymers that are derived from the petroleum refining. The motivations driving innovation in this field are both ecological and related to the possibility of deriving an economic benefit thanks to the use of recycled materials as the basis for the production of these alternative plastic compositions.

Researchers' attention is focusing, on one hand, on the possibility of using organic materials and biomass to prepare partially or fully biodegradable polymers and, on the other hand, also on the development of possible functional additives for use inside the polymeric formulations, which are also derived from waste organic materials appropriately selected and processed. In fact, the introduction of additives traditionally used in the preparation of the plastics inside the biodegradable composite polymeric materials could compromise their biodegradability characteristic, especially if such additives are present in large quantities and are not properly selected.

Among the most interesting additive components to be studied in this field, one can certainly identify the so-called “fillers,” or bulking agents, which mainly serve the function of “filler” and consequently allow for a decrease in the total amount of polymer used for the same weight of the mixture. Said fillers are normally used in even fairly high percentages inside the composite polymeric materials and, in general, are found to be inert although, in some cases, they may contribute more or less importantly to determining the physical and/or mechanical characteristics of the finished product.

The possibility of providing a filler derived from organic material waste, to be used inside biodegradable polymer-based compositions, thus achieves, on one hand, the goal of decreasing production costs thanks to a lower use of the polymer itself and, on the other hand, the goal of ensuring the desired biodegradability characteristic of the entire composite material is maintained.

IT102013902147215 describes the production of compostable capsules for the preparation of beverages, constituted by a biodegradable polymer to which is added an organic filler containing polyphenols that, on one hand, allows the capsule to maintain its biodegradability characteristics and, on the other hand, ensures the preservation of the fragrance of the product stored in them. Also for this reason, the inventors selected coffee, tea and/or cocoa as the organic filler to be used; that is, waste products derived directly from the beverage to be prepared.

Instead, U.S. Pat. No. 9,200,128 describes biodegradable resin-based compositions for the production of foam soles for footwear that comprise, among the various additives used in their preparation and use, a filler that may also be of natural origin. In particular, the possibility of using eggshells, which also act as reinforcing agents thanks to their chemical and physical characteristics, is described.

Quiles-Carrillo L. et al. (Polymer Int., 67, 2018) investigated the possibility of using orange peel only to produce flour for use as a reinforcer in PLA-based formulations. The polymer and organic flour, however, appear to have poor relative compatibility, a problem the authors overcame by introducing acrylate/epoxy soybean oil as an essential component of the formulation.

In Wu C-S's study (Polymer Bull., 75, 2018), composite materials containing a modified biopolymer, PBAT-g-G-GMA (poly(butylene adipate-co-terephthalate) grafted with glycidyl methacrylate), and lemon processing waste mechanically processed and chemically treated with a coupling agent to make them compatible with the biopolymer in subsequent processing, are set forth.

Despite the presence of some examples related to the application of organic waste materials inside biodegradable polymeric formulations/composites, there is still a perceived need for an innovative filler additive derived from organic waste materials that is fully biodegradable, easy to prepare and use, does not involve the generation of new waste and can also be included in high percentages into the polymeric formulation.

Optimal would also be the possibility of providing a filler additive with all the aforementioned characteristics and that is able, once homogeneously dispersed inside the selected polymeric base, to positively influence the characteristics of the mixture and products obtained with it (e.g., appearance, hardness, shrink resistance).

### Objects of the Invention

An object of the present invention is to provide a filler additive derived from organic waste materials that is versatile, easy to prepare and use and can be used inside biodegradable polymeric compositions over a wide range of relative polymer/filler quantities.

Another object of the present invention is to provide a biodegradable polymeric composition, comprising the filler additive derived from organic waste materials, that is processable by hot techniques such as, for example, extrusion, injection molding and 3D printing.

Further object of the present invention is to provide a process for the preparation of a filler additive derived from organic waste material for use inside biodegradable polymeric compositions.

These and other purposes are achieved by the object of the present invention, which provides an innovative filler additive derived from waste organic material.

### DESCRIPTION OF THE FIGURES

FIG. 1 shows an image of the filler according to an aspect of the invention and the intermediate and final products obtained according to examples 1 and 2 of the experimental section. In particular: 1a orange; 1b partially dried pressing residues of oranges; 1c orange residue after a first fragmentation and drying step according to Example 1; 1d filler in the form of micronized powder ready for use according to Example 1; 1e pellets according to the formulation of Example 2; If wire according to the formulation of Example 2; 1g item printed with the formulation of Example 2.

### DESCRIPTION OF THE INVENTION

The object of the present invention is a novel additive with filler function for polymeric compositions, prepared from organic residues; in particular, said organic residues are constituted by the waste products of citrus processing and/or pressing.

In the present invention, the terms “filler” and “bulking agent” are considered synonymous and may be used interchangeably.

By the term “polymeric compositions” is meant a mixture of one or more polymers, preferably biodegradable polymers hereafter also referred to as “biopolymers”, and any other functional additives, such polymeric compositions being provided with suitable characteristics so that they can be processed by using hot processing technologies. Examples of these technologies include extrusion, injection printing, and 3D printing, particularly 3D-FDM (Fused Deposition Modeling) printing with pellet- and/or wire-fed printers. Examples, which are not binding, of polymers that may become part of said polymeric compositions, either alone or in mixtures with each other, are polylactic acid (PLA), poly-β-hydroxybutyrate (PHB) and/or polyhydroxyalkanoate (PHA); in a preferred embodiment of the invention it is either PHB alone or a PLA/PHB mixture.

According to a particularly preferred embodiment, the biopolymer that constitutes the composition of the invention is PHB. In fact, this material has inherent advantages over other biopolymers, and PLA in particular. The first advantage concerns its degree of biodegradability; in fact, PHB is a 100% compostable material both in industrial and household waste and in the soil, sea and anaerobic digestion tanks. In contrast, PLA does not have the same performances in terms of biodegradability, as it requires dedicated processes to be disposed of when it is derived from household waste, and also does not show biodegradability processes neither in the sea nor at the soil level.

A second advantage of PHB concerns what its softening temperature is, an inherent characteristic of any polymer that is defined as the temperature at which the material, when exposed to a load, deforms. According to the Vicat tests of ISO 306, PLAS have a softening temperature ranging from 45 to 60° C., depending on the different manufacturers. Instead, PHB has a softening temperature of about 110° C. This inherent characteristic of the two materials is reflected in the fact that, when in contact with water above 60° C. or with hot surfaces such as, for example, the bulbs of lamps, or when the material is present in overheated environments, for example as a component of inner parts of a closed car in the sun, the material with a lower softening temperature tends to deform. Instead, PHB, thanks precisely to its softening temperature of about 110° C., can be safely used to produce containers into which boiling water can be poured and/or which can be put in the dishwasher as well as being suitable for use in the production of design lamps, without the concern that it will undergo deformations when exposed to heat. These possible applications represent only a non-limiting example of possible areas of use of the composition of the present invention.

Partially counterbalancing the advantages just listed, to make PHB currently little used in 3D printing applications, are its processability characteristics with these techniques. In particular, PHB, in contrast to PLA, has a high shrinkage index leading to, as a result of the abrupt cooling that occurs during the printing process (coming out of the hot nozzle where the polymer is in the molten/softened state), the deformation of the items already during 3D printing, making the process virtually impossible. For this reason and despite the aforementioned advantages, PHB is not currently selected as component of choice in the polymeric compositions especially when intended for use in 3D printing.

A possible method used to improve the processability characteristics of a polymeric material is the formation of a “blend” by addition of another polymeric material. However, the so obtained blend will share all the properties of both materials it is made of. In the case, for example, of PLA/PHB blends, one will thus see the desired reduction in shrinkage/deformation of the finished products but also the concomitant loss, at least partial, of their biodegradability and/or lowering of their softening temperature.

A second approach, which can be used to reduce the degree of material shrinkage, is to add additives to the polymeric base. The additive object of the present invention is an excellent technical solution to the problem related to the poor processability of PHB because, when added to the polymeric base of PHB, it optimizes its rheological properties by reducing the shrinkage of the material during printing and the consequent deformation, while keeping intact its positive characteristics: its 100% biodegradable nature as well as its high softening temperature.

The preferred embodiment of the present invention, i.e., the polymeric composition in which the biopolymer is constituted by PHB alone, is thus the solution to the technical problem related to the poor processability of PHB polymer alone by 3D printing techniques, since it allows, on one hand, to maintain the desired heat resistance and biodegradability properties of PHB, while at the same time creating a composition with characteristics suitable for use in 3D printing.

As previously specified, the by-products from citrus processing and/or pressing are the organic residue the filler material is constituted of. Said by-product, also referred to as citrus residue, comprises several anatomical parts of the fruit and mainly the peel, the seeds and the residue of the endocarp. In order to be properly utilized, such by-product must not develop mold nor undergo other uncontrolled chemical and physical changes, and for this reason, its processing must begin within 24 hours after the fruit is pressed. Alternatively, said waste product can be stored for longer periods of time in a refrigerated environment while waiting to be processed; for example, for 15-20 days at a temperature between −2 and +4° C., for 12-18 months at a temperature between −18 and −20° C.

It is important to point out that, in the present invention, said citrus residue does not undergo any washing, sorting, fractionation or cleaning process, prior to the mechanical processing. In fact, the starting organic material is directly used in the subsequent mechanical and drying processes, which will be described below in more detail, to transform it into the filler additive. What was to be considered waste as a whole, and which would have been thrown in the garbage collection, is instead fully utilized without any selection among the different no longer usable parts of the fruit. By the term “citrus” is meant here to refer to the fruits of cultivated plants belonging to the genus Citrus of the Aurantioideae subfamily (Rutaceae family), normally used to produce fresh-pressed juices, juices and/or beverages in general. Non-limiting examples of fruits whose processing and/or pressing by-products may be the starting material for the production of the filler according to the present invention are: oranges, lemons, tangerines and/or grapefruits, alone or in a mixture with each other. Preferably these are the by-products of pressing oranges.

According to a preferred aspect of the invention, the processing of the by-product takes place according to several successive steps that enable its transformation into the filler additive. In particular, it involves implementing mechanical and drying processes that allow: removing the essential oils, reducing the moisture content to a range appropriate for subsequent processing, reducing and equalizing the particle size as well as simplifying the composition of the organic molecules, reducing their level of polymerization. Said reduction in the degree/level of polymerization, naturally contained inside the organic base material for the production of the filler, is desired as it causes the dominant mechanical properties of the polymeric composition to be those plastic properties which are characteristic of the polymeric base in which said filler is dispersed. Furthermore, since the starting organic material is, as mentioned above, constituted by different elements (peel, seeds, endocarp residual), the reduction of the degree of polymerization allows obtaining a final filler material with more homogeneous characteristics.

The mechanical and drying treatments that allow achieving the purposes just described can be all of those commonly known to the skilled in the art.

The removal of the essential oils initially present in the by-product can be done by any process known to the skilled in the art, preferably by a cold-pressing process, for example, a cold-pressing process carried out by means of a press, in which the compression of the material occurs thanks to the action of a piston with screw or hydraulic movement, or by using a hydraulic press, preferably by means of a press. According to a preferred aspect of the invention, to ensure the removal of all oily and liquid components from the substrate, the pressing operation can be repeated more than once and/or until no more liquid is observed to spill out after the piston or press descends.

The particle size reduction (grinding, pulverization, and/or micronization) will be carried out in a single step or, more preferably, in several successive steps until the desired size is obtained, by using mills and/or micronizers of the size and with a grinding/pulverization/micronization technology appropriate to the initial product size and the final size to be achieved; for example, blade mills, ball mills, stone mills, micronizers, preferably blade mills, can be used. The products obtained from the grinding/pulverizing steps may be sieved, between a grinding step and the next one and/or in the final step, in order to select homogeneous particle size fractions. Particularly preferred are fractions characterized by particles having a sieve diameter of less than 300 μm. The sieving can be done by using any method known to the skilled in the art; according to a preferred aspect of the invention electric vibrating sieves (vibrating screen) are used.

The drying processes can be carried out in static or dynamic drying equipment, such as for example in stoves or tray dryers. The process temperatures and times vary depending on the characteristics of the raw material.

In a preferred embodiment of the invention, three different drying processes are performed for the preparation of the filler additive in order to make the mechanical processes to which the by-product is to be subjected more efficient. In particular, an initial drying, upstream of grinding, a second drying before micronization and a final drying at the end of all mechanical processing may be carried out. According to a preferred embodiment of the invention, the end product of the organic residue processing must have a moisture content of less than or equal to 6%, preferably less than 3%, particularly when the filler of the invention is used in a mixture with the biopolymer (or mixture of biopolymers) to produce filaments for use in 3D printing processes.

Object of the present invention is also the polymeric composition as previously described, in which the filler additive obtained from waste products of the citrus processing is present along with at least one biopolymer. Preferably said filler additive, or bulking agent, is added to the polymeric composition in an amount between 0.1 and 70% by weight to the total weight of the mixture. More preferably between 1 and 70% by weight, even more preferably between 5 and 65% and even more preferably between 10 and 60% by weight.

According to a preferred aspect of the invention, the biopolymer comprised in the polymeric composition is poly-β-hydroxybutyrate (PHB). In fact, as previously mentioned, the use of said biopolymer inside the polymeric composition of the invention has a number of advantages over the state of the art, especially in relation to the possibility of using PHB even with normally unsuitable processing techniques, such as 3D printing.

According to another aspect of the invention, the polymeric composition comprises the polylactic acid and/or poly-β-hydroxybutyrate as the biopolymers of choice. As previously described, the biopolymer of choice can be used alone to form the polymeric fraction of the composition or be in a mixture with a second polymeric material, preferably a second biopolymer. Advantageously, the polylactic acid and poly-β-hydroxybutyrate can be used in a mixture with each other. Preferably, the second biopolymer is added in amounts between 0.1 and 50% by weight to the total weight of the polymeric composition, even more preferably in amounts between 5 and 30% by weight.

If desired or necessary, the composition of the invention, constituted by at least one biopolymer added with the filler obtained from waste products of the citrus processing, particularly waste products of the orange processing, may optionally comprise additional functional additives. Said functional additives can be selected from those known to the skilled in the art and normally used in the field of hot processing technologies of polymeric compositions, previously described.

In a preferred embodiment, the polymeric composition of the invention comprises, for example, one or more release agents. Preferably, the release agent is added in amounts between 0.1 and 3% by weight to the total weight of the mixture and is a release agent of natural origin, for example, but not only, a vegetable wax.

According to another preferred embodiment, the polymeric composition of the invention also comprises one or more mineral fillers, preferably in an amount between 0.1 and 30% by weight to the total weight of the mixture. Said mineral fillers can be of different origin and nature and be vegetable (e.g., starches, fibers made from coconut), mineral (e.g., calcium carbonate, talc, plaster) or synthetic (e.g., thermoplastic resins, thermosetting resins).

Preferably, the polymeric composition of the invention also comprises one or more fluidifying agents, advantageously in an amount between 0.1 and 2% by weight to the total weight of the mixture. Said fluidifying agents can be selected from those known to the skilled in the art and commercially available such as, for example but not limited to, FerroFlow (Ferroplast) or TP P1810 agent (Bruggolen).

The polymeric composition of the invention, in its preferred implementation, will comprise at least one biopolymer or a mixture of two biopolymers, the filler derived from waste products of the citrus processing and/or pressing, and one or more additional functional additives preferably selected from release agents, fluidifying agents and mineral fillers.

The polymeric composition according to the invention is advantageously usable in the field of all the hot processing techniques of the polymer materials known to the skilled in the art; the extrusion, injection molding, and 3D-FDM printing with pellet- and/or wire-fed printers are particularly preferred.

In fact, the composition of the invention can be advantageously prepared for its use with the aforementioned technologies by mixing all of its constituent components and producing, through the use of an extruder, preferably a twin-screw extruder, a product in the form of pellets or in the form of a filament, also referred to as wire. Said product in pellet or wire form will have all the optimal characteristics for its use according to hot processing technologies of the polymeric materials known to the skilled in the art, particularly the extrusion, injection molding, and 3D-FDM printing by pellet- and/or wire-fed printers.

Thanks to the peculiar characteristics of the composition according to the invention, its application in the field of 3D-FDM printing will be particularly preferred and advantageous, both by using pellet-fed printers but also in the case of using wire-fed printers, which allow the production of more precise items and characterized by more details.

By way of example but not limiting, by using the composition of the invention, items of different types and sizes such as, for example, chairs, lamps, containers, vases, installations, jewelry, plates, cups, etc., can be produced.

The polymeric composition according to the invention can boast both performance and aesthetic advantages over the base biopolymer alone and supplemented with traditional fillers. In particular, from an aesthetic point of view, the composition of the invention allows obtaining manufactured articles that no longer have the characteristics that are commonly associated with the plastic items, shiny to the eye and smooth to the touch, in favor instead of a marked increase in the perception of the “organic” origin of the final material, which is in fact opaque to the eye and rougher to the touch. This is particularly advantageous especially in the field of, for example, the design industry, which is increasingly concerned about the environmental impact of its products and tends to favor the use of more natural-looking materials but at the same time appreciates the possibility of using innovative technologies such as 3D printing.

Also, from the point of view of the performance characteristics, the polymeric composition of the invention, thanks to the use of the filler additive obtained from the waste products of citrus pressing, is found to possess several advantages. In particular, the presence of the filler according to the present invention results in greater stability of the composition to the temperature, thus allowing, for example, the possibility of expanding the range of processing temperatures without the danger of degrading the biopolymer component. The ability to increase the process temperatures is useful in that, for example, it allows the viscosity of the polymer to vary in the molten state and thus results in its improved processability even through small nozzles. Furthermore, the ability to increase the fluidity of the polymer allows for faster 3D printing. Finally, the fact that the polymer they are made of has a higher softening temperature allows to broaden the functionality of the items produced; in fact, this is a key feature in the case of producing items that, for their functions, must come into contact with water or liquids close to 100° C. (e.g., cups, spoons, tableware in general). Thus, said items resistant to high temperatures can also be washed in the dishwasher, thus facilitating their use not only in domestic settings but also in the field of public catering.

Finally, the increased stability of the composition to the temperature is also important in the case of the production of design items, such as lamps, vases or trivets, which, by their nature and function, may be in contact with hot surfaces and/or heat sources for prolonged periods of time.

A further performance advantage of the polymeric composition according to the invention is that, once in the cooling step after hot forming the article, said composition has little tendency to warpage/shrinkage (warpage shrinkage phenomena). These negative phenomena, which are well known and studied in the field of hot polymer processing techniques, are brought about by the nature of the plastic polymer which, as it cools into the shape of the final manufactured article, tends to shrink and, in the worst cases, distort due to a non-uniform shrinkage along the different axes.

The presence of the filler additive obtained from the waste products of citrus pressing, particularly orange pressing, inside the polymeric composition of the invention allows a significant reduction in these warpage/shrinkage phenomena thanks to an increase in the stiffness of the finished product, thus making the polymeric composition according to the present invention particularly suitable for the application in injection and 3D-FDM printing technologies.

Finally, the invention object of this patent application can fit perfectly within the concept of circular economy, which has been much studied and coveted in recent years as a possible solution to current environmental problems. In fact, the composition of the invention allows to breathe new life into a totally organic product that is considered waste and cannot be reused, by creating items made of a completely biodegradable recycled material.

Furthermore, the possibility of using, as a starting material for the filler additive of the present invention, the citrus residue in its entirety and thus all of the different anatomical parts of the fruit of which it is made (mainly peel, seeds and endocarp residue), is another of the particularly advantageous aspects of the present invention over the known art. In fact, there is no need for fractionation, washing or cleaning/sorting of the starting organic material which can be directly routed, as it would have been put in the waste collection, to the subsequent mechanical and drying processes previously described, to transform it into the filler additive.

In the following Experimental section, examples of the preparation of the filler additive according to the invention, examples of the preparation of the polymeric compositions comprising it and an example of their use in 3D-FDM printing will be illustrated for illustrative and non-limiting purposes.

### Experimental Section

### Example 1—Polymeric Composition Constituted by a PLA PHB Mixture and Filler Obtained from the Orange Pressing Waste

### 1.1—Pressing

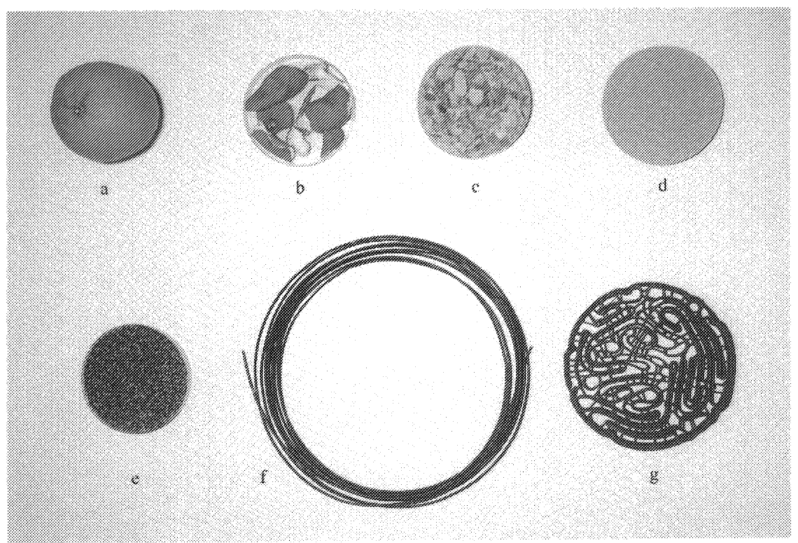

2,000 kg of oranges (FIG. 1a) are pressed by using the Citrus Cutter system, in which the fruits placed in the vibrating feed hopper are picked up and pushed against a fixed knife that cuts them into two halves. The half fruits end up against plastic cups where, by means of rotating pins, the juice extraction takes place.

The pressing residue (FIG. 1b, dry product) is then placed in a press where the compression of the material, which occurs by the action of a hydraulic piston, allows the essential oils to be extracted. In order to flush out the liquid fraction present in the pressing residue, several successive operations are required. In this specific case, the compression is repeated five times.

The weight reduction at the end of the process is equal to 80%, with a residual moisture content of about 75%.

### 1.2—Filler Preparation

The material obtained (commonly referred to as citrus residue) is ground by a grinding system with a high-strength steel gear rotating at low speed. The material is thus coarsely cut and crushed by a slowly rotating roller with sharp teeth.

The comminuted citrus residue is placed in a dryer, with air extraction, at a temperature of 80ºC for about 8 h, resulting in a 10% reduction in residual moisture and an additional 77% weight loss.

The dried citrus residue (FIG. 1c) is then micronized through the use of a blade mill and sieved with a 300 μm mesh vibrating sieve. The larger size material left inside the sieve undergoes a second micronization process and subsequent re-sieving in order to recover all the material.

Following the micronization, an additional drying cycle is carried out by following the same process explained above, thus obtaining the powdered filler with the optimal characteristics for its subsequent processing (FIG. 1d). The final residual moisture is equal to 3%.

The amount of filler resulting from the process is equal to 88 kg.

### 1.3—Compounding

The compounding process is carried out by using a laboratory twin-screw extruder, with a 12 mm diameter and 36 L/D ratios, with which dispersive and distributive melting and mixing of the selected polymeric base, together with the other elements of the formulation, are performed in order to obtain a homogeneous mixture to be extruded as a wire subsequently cut into pellets.

The polymeric composition utilized provides for the use of the filler from oranges, prepared according to the description in Section 1.2, in an amount equal to 30% by weight to the total mixture and a mixture of PLA/PHB, in a relative weight ratio of 60/40 equal to about 70% by weight to the total weight. Additionally, a vegetable wax (Palsgaard) is also added as a release agent in an amount equal to 0.2% by weight to the total and organic peroxide masterbatches (FerroFlow) as a fluidifying agent in an amount equal to 1% by weight to the total weight.

The pellet is cut to a maximum size of 5 mm in length so as to facilitate the subsequent extrusion process for 3D printing.

### 1.4-3D-FDM Printing, Pellet-Fed Printer

The pellets obtained according to the process described in Section 1.3 are used for 3D-FDM printing with direct extrusion of the pelletized material. In particular, said material is tested on a Cartesian 3D printer equipped with a pellet single-screw extruder. This is done by placing 100 g of pellets into the extruder tank, which is preheated to a temperature of 200-210° C. before starting the printing process at an average speed of 20 mm/s (maximum speed 35 mm/s). The printing proceeds steadily, completing the item selected for the test in 115 minutes.

### FDM 3D Printing Technical Specifications:

Extrusion temperature: 190-215° C.
Maximum printing speed: 35 mm/s, the speed at which the printer's extruder can consistently and continuously deposit material, with a material output flow of 90%-100% and a printing temperature of 215° C.
Temperature of the printing plate: 50-70° C.

The printed item (FIG. 1g) has a light brown color and a matte finish; upon coming into contact with water for a prolonged time (24 hours), color loss is observed. In case of hot water (100° C.), the item not only loses color but also undergoes deformation.

### Example 2—Polymeric Composition Constituted by PHB and Filler Obtained from the Pressing Waste from Mixed Citrus

### 2.1—Pressing

2,000 kg of mixed citrus (50% oranges, 35% lemons, 15% tangerines) are subjected to pressing by using the Citrus Cutter system in which the fruits placed in the vibrating feed hopper are picked up and pushed against a fixed knife that cuts them into two halves. The half fruits end up inside the plastic cups where, by means of rotating pins, the juice extraction takes place.

The pressing residue is then placed in a press where the compression of the material, which occurs by the action of a hydraulic piston, allows the essential oils to be extracted. In order to flush out the liquid fraction present in the pressing residue, several successive operations are required. In this specific case, the compression is repeated five times.

The weight reduction at the end of the process is equal to 76%, with a residual moisture content of about 73%.

### 2.2—Filler Preparation

The material obtained (commonly referred to as citrus residue) is first ground by a grinding system with a high-strength steel gear rotating at low speed. The material is thus coarsely cut and crushed by a slowly rotating roller with sharp teeth.

The comminuted citrus residue is placed in a dryer, with air extraction, at a temperature of 80° C. for about 8 h, resulting in a 9% reduction in residual moisture and a consequent additional 72% weight loss.

The dried citrus residue is then micronized through the use of a blade mill and sieved with a 300 μm mesh vibrating sieve. The larger size material left inside the sieve undergoes a second micronization process and subsequent re-sieving in order to recover all the material.

Following the micronization, an additional drying cycle is performed with the same process as outlined above. The final residual moisture is equal to 2.7%.

The amount of filler resulting from the process is equal to 123 kg.

### 2.3—Compounding

The compounding process is carried out by using a laboratory twin-screw extruder, with a 12 mm diameter and 36 L/D ratios, with which dispersive and distributive melting and mixing of the selected polymeric base, together with the other elements of the formulation, are performed in order to obtain a homogeneous mixture to be extruded as a wire and cut into pellets.

The polymeric composition utilized provides for the use of the filler from citrus, prepared according to the Section 2.2, in an amount equal to 30% by weight to the total weight and PHB equal to about 70% by weight to the total weight. Additionally, a vegetable wax (Palsgaard) is also added as a release agent in an amount equal to 0.3% by weight to the total and organic peroxide masterbatches (FerroFlow) as a fluidifying agent in an amount equal to 0.8% by weight to the total weight.

The pellet (FIG. 1e) is cut to a maximum size of 5 mm in length in order to facilitate the subsequent extrusion process for 3D printing.

### 2.4—3D-FDM Printing, Wire-Fed Printer

800 g of pellets are used to produce the filament by using a single-screw extruder, which melts the pellets at a temperature set between 130-160° C.

The appropriate extrusion speed for the purpose of producing a filament such a biomaterial is 7-12 rpm (revolutions per minute), which are the revolutions that the screw makes on itself in one minute inside the polymer melting chamber.

Once adequate and constant temperature and speed are reached, the wire produced by the extruder is pushed through a 2 mm diameter nozzle and pulled by a pulley in order to obtain a filament diameter of 1.75 mm (FIG. 1f).

The wire, after being reeled in, is used to print with a 3D-FMD printer, delta model. The printer extruder pushes the wire to the hot end, Volcano type, with a 1 mm nozzle. The extruder is preheated to a temperature of 205° C. before proceeding with printing at a speed equal to 40 mm/s (maximum speed 50 mm/s). The printing proceeds steadily, varying the printing temperature between 175-205° C., thus completing the item selected for the test (FIG. 1g) in 70 minutes.

### FDM 3D Printing Technical Specifications:

Extrusion temperature: 175-205° C.
Maximum printing speed: 50 mm/s, the speed at which the printer's extruder can consistently and continuously deposit material, with a material output flow of 90%-100% and a printing temperature of 205° C.
Temperature of the printing plate: 80-100° C.

The material in filament form is flexible and easy to reel in and use in the 3D printing process even weeks after its production.

The polymeric base has a lower melting point (so it can be extruded at lower temperatures) but it has a higher softening temperature, in fact the printed products withstand higher temperatures, up to 100° C. It is noted that the presence of the filler, compared to the polymeric base alone, makes the 3D printing process more stable, thus reducing the shrinkage phenomenon of the polymer, and helps to increase the resistance to high temperatures, up to 100° C.

The printed item is dark brown in color, slightly shiny.

The contact with water does not cause a marked loss of color, although a slight change in the color of the water itself may be noted. In case of hot water (100° C.), the printed item doesn't show any deformation.

1. A filler additive for biodegradable polymeric compositions, characterized in that it derives from the unselected mixture of the waste products of citrus processing and/or pressing.

2. The filler additive according to claim 1, characterized in that said citrus are oranges.

3. The filler additive according to claim 1, characterized in that it has a final moisture content of less than 3% and a sieve diameter of less than 300 μm.

4. Use of the filler additive of claim 1 as a filler in biodegradable polymeric compositions.

5. A biodegradable polymeric composition comprising the filler additive of claim 1 and at least one biodegradable polymer.

6. The polymeric composition according to claim 5, characterized in that said biodegradable polymer is selected from PLA, PHB or a mixture thereof.

7. The polymeric composition according to claim 5, characterized in that said biodegradable polymer is PHB.

8. The biodegradable polymeric composition according to claim 5, characterized in that it also comprises at least one functional additive selected from release agents, fluidifying agents and mineral fillers.

9. Use of the biodegradable polymeric composition of claim 5 for producing items by hot processing techniques selected from extrusion, injection printing and 3D printing.

10. Use according to claim 9, characterized in that said hot processing technique is 3D-FDM printing by means of printers fed by pellets and/or threads.

11. A product obtained by hot processing techniques using the polymeric composition of claim 5.

12. The product according to claim 11, characterized in that said polymeric composition of claim 5 has a softening temperature higher than 90° C.
